(19) United States
(12) Patent Application Publication
(10) Pub. No.: US 2002/0133293 A1
(43) Pub. Date: Sep. 19, 2002

(54) Concealable portable GPS communication system

(75) Inventor: Howard B. Goldman, Tonawanda, NY (US)

Correspondence Address: William J. Crossetta, Jr., Crossetta & Associates, 905 Convention Towers, 43 Court Street, Buffalo, NY, 14202, US

(73) Assignee: HOWARD GOLDMAN, INC

(21) Appl. No.: 09/809,399

(22) Filed: Mar. 16, 2001

(51) Int. Cl. G01C 21/20

(52) U.S. Cl. 701/213; 342/357.06

(57) ABSTRACT

A portable GPS communication device and system is disclosed, the device being particularly suitable for magnetic mounting on the undercarriage of a vehicle, the device comprising a unique patch antenna arrangement wherein stacked plates are intimately encased in a polymer comprising conductive metal particles, arranged to enable electromagnetic reception without a direct line-of-sight view of orbiting satellites, the device also comprising a conventional portable GPS processing unit which determines location of itself and a conventional wireless two-way communication means arranged to receive data from the GPS unit and transmit location data to a remote communication means by remote command. The system has particular utility when overlaid on the internet to provide remote computer observation of location and remote control of device operating parameters.

### TECHNICAL FIELD

The present invention relates to easily concealed portable GPS communication systems, particularly to remote readable, readily attachable GPS communications systems and devices, which can be quickly and conveniently secreted along the undercarriage of mobile vehicles and will maintain communication with common GPS satellite arrays for remote determination of location.

### BACKGROUND OF THE INVENTION

Satellite navigation systems, generally referred to as GPS systems, are well known in the prior art and have become useful tools for the determination of location of mobile vehicles, such as cars, trucks, trains, boats, planes and the like.

In a typical application, a GPS operating unit comprises an antenna which is generally positioned to enable line of sight receipt of a radio transmission from two or more orbiting satellites. Electromagnetic transmissions from the satellites are processed by the GPS unit wherein it is generally converted to digitized data which is then generally compared for various transmission characteristics and/or to other known data, with position being calculated and/or selected by the unit through conventional triangulation software, the unit displaying or otherwise providing information to the user concerning location as appropriate.

One problem inherent with GPS unit operation is assuring adequate reception of signals from the satellites and/or ground antennas which may be sending and/or relaying radio transmissions, to enable the GPS processor to provide efficient and/or accurate results. Generally, hand held units can be manipulated to position their generally built-in antenna as may be appropriate to attain usable reception for processing. GPS units useful with mobile vehicles are generally provided with an antenna which is affixed to the vehicle remote from the GPS processing components. Since signal reception from two or more sources is a key element to the efficiency of the GPS unit, the conventional thinking is that a GPS antenna must be affixed to a mobile vehicle in a manner which maximizes direct line of sight reception from appropriate overhead satellites and avoids real or potential signal interference which might be occasioned by radio transmission interfering structure and the like, inherent to the mobile vehicle.

The prior art is replete with antenna arrangements which are designed for generic radio signal reception to be mounted in top side locations on mobile vehicles which minimize blocking of electromagnetic transmitted signals by vehicle structure, but are very visible to the casual observer. Generally, attempts have been made to obscure the visibility of radio antenna arrangements from the casual observer, such as for example by incorporating thin wire antennas in a windshield glass, by incorporating an antenna in exterior lighting units and/or decorative trim and the like, by installing an antenna on windows adjacent structural posts and the like, or using retractable antennas which can be retracted or extended at the control of the user or automatically. Such antenna arrays can be useful in obscuring the antenna from the casual observer, but generally are so publically well known that they become easily recognized by an interested observer.

Antenna arrays useful for receiving GPS signals, are generally unique in design appearance, thus are even more readily apparent to an interested observer. GPS units installed in vehicles are particularly recognizable by interested observers, in that they not only generally have a distinctive exterior mounted antenna, but also comprise distinctive electronic packaging such as dashboard displays and the like which are easily visible to casual view.

To thwart theft, GPS units have been installed in vehicles as protective tracking devices for detection and recovery of stolen vehicles. Given suitable installation circumstances, structural modification of a vehicle and/or the cooperation of persons in control of the vehicle, GPS processing units can be secreted in generally unexpected locations in the vehicle and suitable antenna means can be secretly mounted among various innocuous visible accessories and the like so as to not be readily apparent.

Conventional thinking regarding GPS antenna placement generally limits antenna placement to visible top surfaces of a mobile vehicle for overhead line-of-sight reception from a satellite, generally requiring changes to a vehicle which are soon recognized by the discerning and even the casual observer. Thus, even GPS antennas factory installed by the original manufacturer for use of GPS to thwart theft of a mobile vehicle are soon publically known and recognized by an experienced car thief, who then merely destroys or otherwise disables the antenna as a precursor to stealing the vehicle.

Further, in the modern world, there is an increasing need to surreptitiously track the location and/or movement of a mobile vehicle. Investigatory, law enforcement and the like agencies, have frequent need to track the movements of persons and/or goods, and generally have a need to track the movements of a vehicle carrying such persons or goods in a manner secretive to persons in actual control of the vehicle and/or others who may be observing the vehicle. Remote tracking of vehicles and/or goods is desirable in that it reduces the risk of discovery and/or personal confrontation. Remote GPS tracking of such vehicles enhance both investigator and investigation security.

The mounting and/or attachment of commonly available GPS units in a vehicle generally requires significant time and effort to accomplish when secrecy from the user and/or passengers of the mobile vehicle is desired. Generally, conventional units require connection to the vehicle's electrical system and mounting a conventional antenna secretly obscured from casual and/or curious observation from persons using the vehicle. Visible change to a vehicle which is familiar to persons in control of its use, can provoke curiosity, and the conditions and time necessary to secretly install without detection of such visible change, may not be available to an investigatory agency.

Thus, it is an object of the invention to provide a GPS tracking device which can be quickly and easily secretly mounted to a vehicle to enable secure and efficient tracking of the vehicle.

It is a further object of the invention to provide a device which provides efficient remote tracking of movement of a vehicle.

A still further object of the invention is to provide an antenna which can be conveniently mounted among vehicle structural elements not normally conducive to reception and thus be secreted in an unexpected location therefore.

A still further object of the invention is to provide an efficient method of mounting a portable GPS tracking device and track movements of a vehicle which is particularly convenient to remote tracking from multiple locations.

These and other objects of the invention will become apparent from the following recitation of the invention.

### SUMMARY OF THE INVENTION

The present invention generally comprises a portable GPS two-way communication device and method of remote tracking, the device being adapted for quick and convenient attachment/detachment to a generally obscure surface of a vehicle, and arranged in wireless remote controlled system communication with a user at a remote site.

The device comprises a unique GPS antenna, a GPS signal processor and a first wireless communication means arranged in a unique system to communicate between the GPS signal processor and a remote second wireless communication means. In a general embodiment of the invention the unique GPS antenna is in communication with a GPS signal processor which is hard-wire married to the wireless first communication means all in a self-contained battery powered unit, the GPS signal processor being in part controlled by signal from the first wireless communication means to send positional data back to the first wireless communication means for wireless transmittal to a remote second wireless communication means.

In a further preferred embodiment, the first wireless communication means generally comprises conventionally available cellular, satellite and/or wireless paging communication means enabled to send positional data to a particular wireless receiver address in communication therewith, which in turn is downloaded to computer means in communication therewith. In a particularly preferred system of the invention, computer means is inter-linked through the internet to serve one or more users who may have access to positional viewing and/or data sent to the address, and/or enabling determination of positional location of an identified communication and/or control of various aspects of the communication, generally including enablement and/or disablement of GPS processing and/or signal transmission by the GPS tracking device.

In a further preferred embodiment of the invention, the device is powered by one or more self-contained power sources, the first wireless communication means and/or GPS processing means comprising a reduced power consumption mode which doesn't awake to process and/or transmit GPS data unless remotely signaled and/or is enabled to automatically transmit data to the remote receiver at predetermined intervals. It should be understood that such intervals include predetermined time intervals and/or activity sensing intervals, such as movement and/or activity within and/or associated with the vehicle. It should also be understood that positional data may be collected continuously and/or at intervals by the GPS processor, which in turn can be transmitted by the first wireless communication means at intervals and/or when remotely triggered, in real time or in delayed collected data bursts. It is contemplated that within the system of the invention, means may be provided at the remote receiver and/or an address in communication with the remote receiver to save transmitted data for later recall, and that burst and/or other data collected by the GPS processor and/or remotely communicated may be time and date marked and the like as may be appropriate.

Generally, the operable device which is mounted to the vehicle comprises a GPS processor, hard-wire married to a first portable wireless communications receiver/transmitter through well known techniques. Such devices are conventionally known in the art and commonly available. The first wireless communications receiver/transmitter, can be any appropriate portable cellular, satellite and the like receiver/transmitter that enables wireless data transmission and/or reception, such as conventionally available cellular and/or satellite telephone and/or pager communication type systems. Generally, such conventional wireless communication systems comprise their own built-in antenna for communication therewith, and it has been generally found that no special remote antenna is generally necessary to attain appropriate wireless radio communication reception and/or transmission with a remote wireless receiver and transmitter, even when such conventional wireless communication systems are secreted among structural elements of a mobile vehicle that might ordinarily block reception of GPS signals.

Similarly, it has been found that conventional hand-held GPS processor units are suitable for use in the present invention and can be easily married to conventional wireless communication systems, by known techniques, but that antenna conventionally available for use with such hand-held GPS units are generally inadequate when secreted within mobile vehicles having metal structure in that the metal structure tends to block the collection of signals and unless the antenna is arranged for unblocked, generally direct alignment of the antenna with two or more GPS positioning satellite transmitters, the ability of the convention GPS processor to provide accurate positional data is compromised.

A type of antenna conventionally used as a GPS antenna is commonly known as a patch antenna, and generally comprises two metal plates sandwiching a ceramic or the like central plate in a stacked array for capturing radiated electromagnetic energy from satellite GPS transmitters. The stacked plate array is conventionally mounted to a mobile vehicle so that the plates are generally directionally oriented to face vertically to maximize reception of GPS signals from satellites orbiting overhead. In such mounted arrangement the bottom plate in the array, generally a thin metal plate referred to as the ground plate, is directionally oriented such that its bottom flat side is arranged to generally face the earth, and the top plate, generally a thin metal plate referred to as the positive plate, is directionally oriented such that its top flat side generally faces upwardly toward orbiting GPS satellite positions. Generally such stacked plate array is housed in an otherwise empty plastic rectilinear box, preferably Mylar coated, with a conductive wire connected to each opposing plate for connection with a GPS processing unit. In a preferred conventional arrangement, electronic circuitry is arranged at about the stacked plate array, generally enabled to convert or otherwise enhance the electromagnetic signal for use by the GPS processor.

Such arrangement of stacked plates and directional orientation of the flat sides thereof is generally conventionally thought to be necessary for the efficient capture of radiated electromagnetic energy from satellite GPS transmitters and line-of-sight orientation is conventionally considered as being a key factor in regard to the efficiency of the antenna and thus a key factor in the manner and place where a GPS antenna may be mounted to a vehicle to attain suitable reception for location.

In accord with such conventional considerations, U.S. Pat. No. 5,918,183 describes some of the extremes used in the prior art for secreting patch type antennas useful in GPS systems. For example, holes are described as being cut in automobile roofs and trunk lids to mount a stacked plate patch antenna with the top flat surface of the positive plate facing generally vertically upward, with elaborate measures being taken to seal, blend and repaint the antenna structure to give the appearance of a continuous unchanged vehicle surface. Other examples include placing an antenna within non-structurally interfering accessories and the like mounted on the metal upper surface of the vehicle to appear as something other than what it actually is.

Applicant has unexpectedly found, that the reception of a conventional GPS stacked plate patch antenna can be considerably improved by a unique modification of the environment immediately intimate the stacked plates. Thus, Applicant has found that when a conventional GPS stacked plate array is encased or at least partially surrounded by a generally non-conductive polymeric composition comprising a random suspension of conductive particles, the reliability of the GPS processor in providing determinations of position is enhanced. In short, Applicant has found that in environments wherein a conventional GPS processing unit using a conventional stacked plate antenna fails to determine location because of inadequate satellite signal line-of-sight reception, that surrounding at least the top side of the positive plate with conductive metal particles, preferably particles of magnesium carbonate, can enhance reception sufficient to determine location. Such enhancement of reception in turn enhances the reliability and thus the efficiency of the GPS processing capability for ascertaining location.

Applicant hypothesizes that the enhanced reception of satellite radiated electromagnetic energy, results from such random metal particles reflecting otherwise dispersed satellite radiated electromagnetic energy toward the face surface of the positive plate of the antenna. Indeed, Applicant has found that when such particle surrounded stacked plate antenna is positioned to minimize or even structurally exclude line-of-sight reception of satellite radiated electromagnetic energy, that sufficient radiated energy can be collected from dispersed energy reflected from man-made and natural structures adjacent to the immediate environment of the antenna to enable location processing by the GPS processing unit.

For example, Applicant has found that if such unique enhanced stacked plate antenna is mounted beneath a vehicle in an arrangement wherein metal structure known to interfere with direct satellite line-of-sight electromagnetic radiation, in such manner as to have only line-of-sight visibility to earth, it will collect sufficient reflected electromagnetic energy radiated from a satellite to provide sufficient data for efficiently determining position by conventional GPS processing units. Such finding appears to be true even if the direct line-of-sight visibility of the antenna to earth extends merely to about the margins of the vehicle. Such finding appears in conflict with conventional direct line-of-sight teachings.

In addition, Applicant has found that if the unique antenna is spatially oriented on a metallic underside of a vehicle so that the flat sides of the ground and positive plates face toward the horizon, instead of facing generally vertically upwardly toward satellites as is the conventional teaching, its reception efficiency further improves and that even greater reception efficiencies are obtained when the placement of the antenna is such that the ground plate of the vertically oriented antenna faces along a greater vehicle mass than the positive plate.

Indeed, in a preferred spacial orientation, the unique antenna of the invention is mounted to the underside of a vehicle with ground and positive plates spacial oriented to face toward the horizon with the exterior flat surface of the positive plate being greater than about 6 inches from an external margin of the vehicle.

In a preferred assembly of the invention, a stacked plate GPS antenna assembly is conventionally formed comprising a ground wire in electrical connection to a GPS ground plate of the antenna and a positive wire in electrical connection to a GPS positive plate of the antenna, a ceramic or the like plate separating the ground and positive plates, connected wires being arranged from direct electrical contact to each other for electrical conduction to signal enhancing circuitry and/or the GPS processor means. The assembly may comprise signal enhancing electronic circuitry, which is generally arranged opposite the bottom side of the ground plate, prior to conduction to the GPS processor means. The antenna assembly is then encased in a supporting structure comprising a suitable polymeric resin composition having metal particles mixed therein. In a preferred embodiment, the assembly is immersed in a fluid mixture comprising magnesium carbonate powder, polyester resin and styrene monomer, talc and sodium borosillicate. The mixture is cured to form a hardened, integrally encased antenna with conductively distinct ground and active lead wires extending therefrom.

In a particularly preferred embodiment, the particulate metal content is generally distributed generally consistent throughout the encapsulating material, the exterior structural margins of the molded encasement is in the form of a generally rectilinear box, and the positive plate is arranged at a greater distance from the exterior structural top margin than the distance from the ground plate to the exterior structural bottom margin, such that a greater total mass of particulate metal is immediately adjacent the positive plate than the ground plate. It should be understood that in a typical embodiment, the encapsulating material directly engages both the exposed face of the positive plate and the exposed face of the ground plate, but in a preferred embodiment wherein integrated electronic circuitry to enhance the received signal is immediately adjacent the bottom surface of the ground plate, protective shrouding of the circuitry can preclude direct engagement of the encapsulating material with the facing surface of the ground plate, without apparent significant loss in effect.

In another preferred embodiment, the antenna assembly of the invention is attached to a bracket, which in turn is configured for quick attachment to the underside of a vehicle. In a particularly preferred embodiment, the bracket is an “L” shaped metal bracket, preferably formed from aluminum, the exterior surface of the long side of the “L” comprising a ceramic magnet of sufficient magnetic strength for convenient magnetic attachment of the bracketed antenna assembly to the underside of a metal floor pan and the like of a vehicle, with the short leg of the bracket extending downwardly. In such embodiment, the antenna is attached to the exterior surface of the short leg, preferably with the ground plate oriented facing the exterior surface of the short leg. In a most preferred embodiment, the antenna is attached to the leg by non-conductive glue, adhesive or the like means in such manner that there is no physical contact among the encapsulating structure of the antenna and the bracket.

The above features and advantages of the invention will become more apparent to those having skill in the art from the following written description, drawings and appended claims.

### BRIEF DESCRIPTION OF THE DRAWINGS

FIG. 1 is a partial sectional, exploded perspective view of an antenna of the invention.

FIG. 2 is a perspective view of an antenna of FIG. 1, attached to a bracket of the invention.

FIG. 3 is a sectional view of the antenna of FIG. 2 taken along about line 3-3′ thereof.

FIG. 4 is a perspective view of an antenna of FIG. 3 illustrating attachment to the underside of a vehicle.

FIG. 5 is a diagrammatic illustration of the GPS device and system of the invention.

### DETAILED DESCRIPTION OF THE DRAWINGS

At the outset, it should be clearly understood that like reference numerals are intended to identify the same structural elements, portions or surfaces consistently throughout the several drawing figures as such elements, portions or surfaces may be further described or explained by the entire written specification, of which this detailed description is an integral part. Unless otherwise indicated, the drawings are intended to be read together with the specification, and are to be considered a portion of the entire written description of this invention.

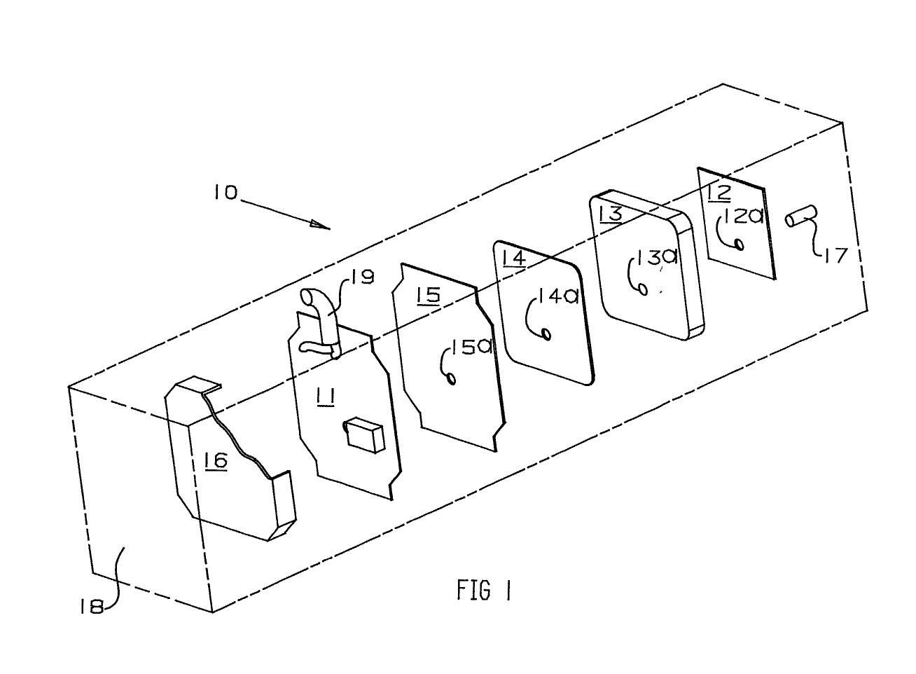

One embodiment of the antenna of the invention is illustrated in FIG. 1. Therein, antenna 10 is shown in exploded perspective as comprising stacked metal positive plate 12, ceramic separation plate 13 and metal ground plate 14. In this embodiment, a high dielectric electronic circuit board 11 comprising integrated signal enhancing electronic circuitry, is mounted to a metal shield base plate 15, the exposed electronic surface being surrounded by shroud 16, with the stacked antenna plates being mounted through ground plate 14 to the exterior surface of shield base plate 15. Metal pin 17 has a dual function in that it connects positive plate 12 to the plus side of the electronic circuitry in circuit board 11, while also fixing the components of the antenna in relative mounted position. Ceramic separation plate 13, is significantly thicker than the positive and ground plates and comprises hole 13a extending therethrough sized in diameter to allow pin 17 to pass therethrough in a tight fit. Ground plate 14 is thin and comprises hole 14a, which is sized greater in diameter than hole 13a, while positive plate 12 is thin and comprises a hole sufficient to allow pin 17 to pass tightly therethrough. The ground and positive plates are mounted to opposite surfaces of the ceramic separator plate, with their holes aligned with the hole in the ceramic separator plate, such that when pin 17 is soldered at one end to the exposed face of positive plate 12 and is passed through the ceramic separator and ground plate. Since the hole in the ground plate is of larger diameter than the hole in the ceramic separator, the pin does not engage the ground plate.

Shield base plate 15, comprises a hole 15a which is also greater in diameter than the hole of the ceramic separator plate such that when pin 17 passes through shield base plate 15 into electronics board 11, it does so without engaging shield base plate 15. Thus, fixed soldered engagement of metal pin 17 with circuitry in the dielectric electronics board forms an uninterrupted positive side circuit from the face of the positive plate to the positive side of the electronics circuit board, and fixes the stacked plates in aligned position on the shield base plate. Shroud 16, is configured to surround the otherwise exposed surface of electronics board 11 without engaging the electronic circuitry and comprises an opening for dual conductor antenna wire 19 to exit from positive and negative connection to the electronics board and/or shield base plate, to the GPS processor.

In the preferred embodiment illustrated in FIG. 1, a cured hardened resin mixture 18 is illustrated as surrounding the stacked plates, including the shield base plate and shroud, by phantom lines representing the exterior margin of the resin, containing therein random particles of magnesium carbonate powder 19, mixed therein. In a preferred embodiment, the resin mixture comprises polyester resin and styrene monomer, with talc, magnesium carbonate powder and sodium borosillicate mixed therein.

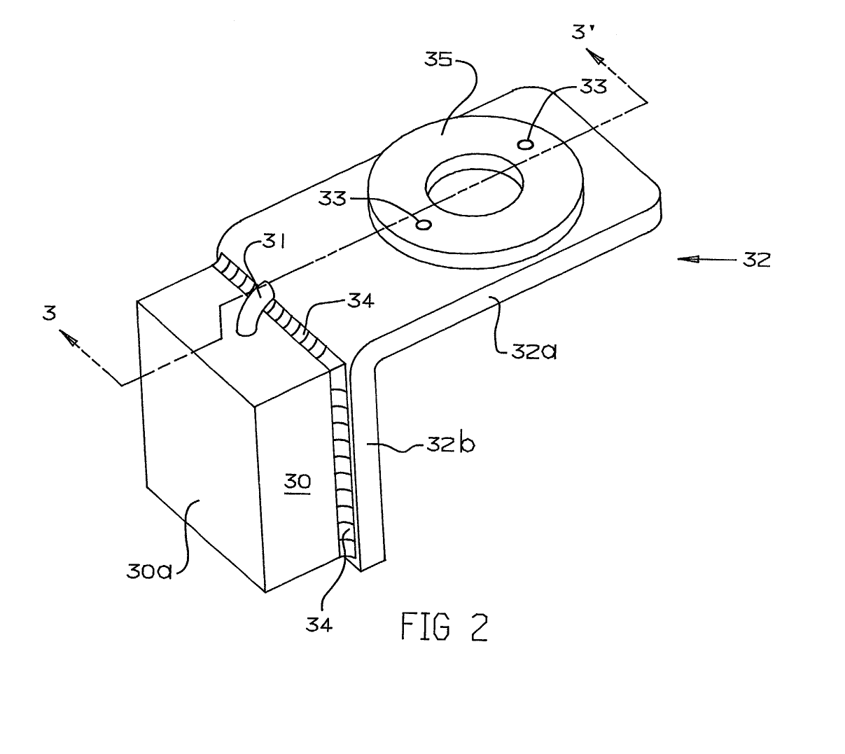

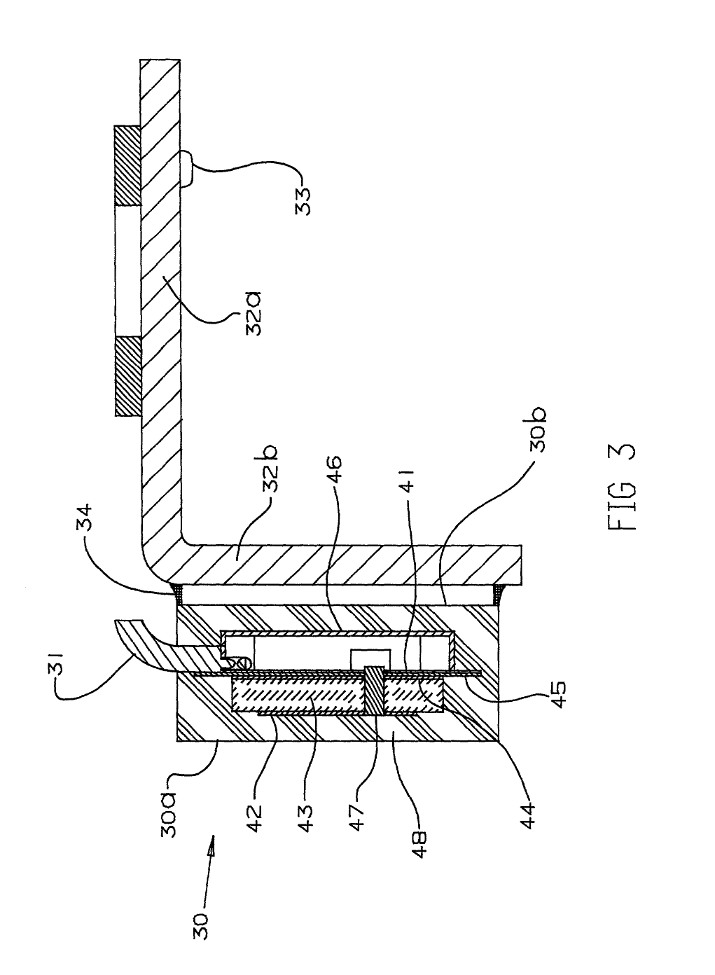

FIGS. 2 and 3 illustrate a preferred antenna assembly having particular utility for mounting to the underside of a mobile vehicle. Therein antenna 30, generally comprises the components illustrated in FIG. 1, the exterior margins thereof being shown as a generally rectilinear molded resin unit, having a dual conductor antenna wire 31 extending therefrom for connection to a GPS processor. Bracket 32 is illustrated as being “L” shaped and formed from aluminum, having a ceramic magnet mounted on the exterior surface of long leg 32a by means of rivets 33. Antenna 30 is mounted to the exterior surface of short leg 32b, in this preferred embodiment by means of non-conductive epoxy 34. Margin 30a of antenna 30 is the margin that the outward face of the positive plate of the antenna faces toward, the ground plate of the antenna facing toward the surface of the short leg. This arrangement of the antenna on an aluminum bracket appears to even further increase the efficiency of the antenna.

FIG. 3, particularly illustrates the relationship of the components of antenna 30 in their mounted arrangement. Therein, the assembled relationship of pin 47 fixing the position of metal positive plate 42, ceramic separation plate 43, metal ground plate 44, metal shield base plate 45 and electronic board 41 is illustrated, with shroud 46 covering the exposed electronic circuitry and cured resin mixture 48, containing random magnesium carbonate particles, surrounding the components in a preferred embodiment wherein antenna margin 30b is adjacent shroud 46 and non-conductive epoxy 34, spaces antenna 30 from engaging short leg 32b.

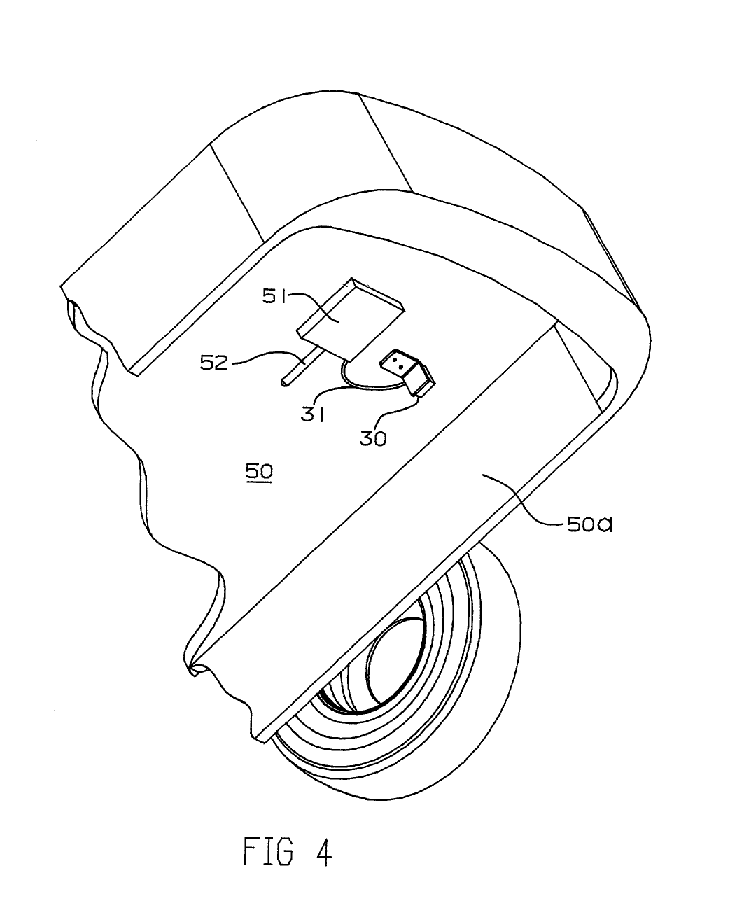

FIG. 4 illustrates a preferred mounting arrangement of the antenna arrangement of FIG. 3. Therein is illustrated the metal underside of an automobile 50, in this embodiment an area below about the rear of a car, wherein the antenna arrangement is magnetically mounted to the underside, such that the face of the ground plate is oriented to face horizontally toward side margin 50a of the automobile thus facing a lesser proportion of the undersurface of the automobile than the ground plate. GPS antenna 30 is connected by antenna wire 31 to the GPS processor. Housing 51 comprises magnetic means or the like for convenient detachable mounting to the vehicle. In this particular embodiment, margin 50a is illustrated as a metal surface extending downwardly from the undersurface of the automobile, to illustrate placement of the antenna on a vehicle without direct line-of-sight view to orbiting satellites.

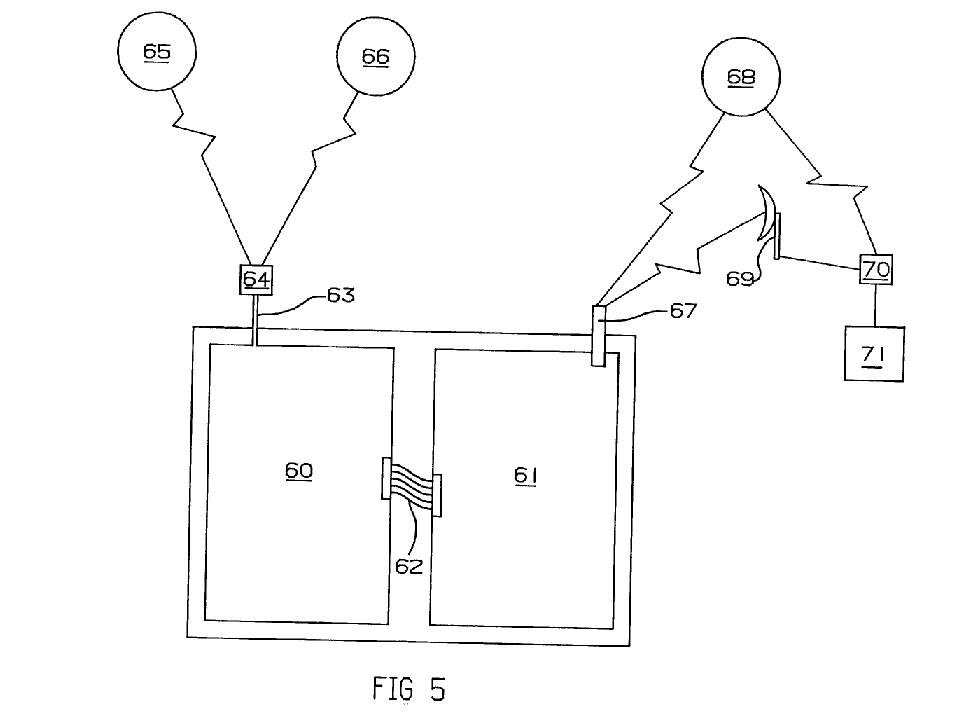

FIG. 5 is a diagrammatic illustration of a portable GPS device incorporated in a system of the invention. Therein GPS processor unit 60 is illustrated as mounted together with first wireless cellular/satellite communications means 61 in a common assembly, connected by wire harness 62, the GPS processor being enabled to receive on/off and/or tuner sensing instructions through the wire harness from communication means 61 and transmit positional data to communication means 61 for wireless retransmission to a remote address. The common assembly is arranged in a housing comprising a ceramic magnet or the like mounted on an exterior surface having sufficient strength to magnetically mount the housing to a metal underside of a vehicle, with the wireless communication having a communications antenna 67 for wireless communication with a remote address. Processor unit 60 is connected by antenna wire 63 to GPS antenna 64, and is enabled to receive signals from the GPS antenna in accord with electromagnetic signals received by the GPS antenna from orbiting satellites 65 and 66. Orbiting satellite 68 and/or cellular receiving means 69 is enabled to receive and send electromagnetic radio signals to and from first communication means 61 in accord with signals received and sent from a remote communication means 70. Remote communication means 70 is illustrated as linked to a user operated computer 71 enabled to receive positional data communicated from said first communication means 61 to said remote communication means 70, and generally comprises software which provides a visual display of location generally superimposed on a geographic area map for the convenient positional orientation of the viewer. In addition, such software generally enables the user to direct actions to be taken including turning on/off the GPS processor and/or first communication means and/or changing communication parameters and the like.

While the best known modes of this invention have been shown herein, applicant does not intend to be limited to the particular details described and illustrated and it is understood the embodiments and details can be altered by one skilled in the art.

I claim:

1. A system for tracking a mobile vehicle comprising:
a device, mounted to the underside of said vehicle, said device comprising a GPS electromagnetic signal processor means in hard-wire connection to a first wireless communication means, said first communication means being enabled for wireless communication with a remote communication means;
GPS antenna means connected to said GPS signal processor means, having stacked ground and positive plates separated by a separator plate, said positive plate having an exposed face engaged by a polymeric composition containing particles of a conductive metal, said GPS antenna means being enabled to receive electromagnetic GPS signals transmitted from an orbiting satellite;
wherein said GPS signal processor means is enabled to generate data from signals received from said GPS antenna means which identify geographic location of said GPS signal processor means; said data identifying geographic location is transported by hard-wire connection to said first wireless communication means; and said first wireless communication means converts said data to an appropriate wireless radio signal and transmits said wireless radio signal to said remote communication means.

2. The system of claim 1 wherein said first wireless communication means is arranged to transmit a signal through hard-wire connection to said GPS signal processor means, which enables said GPS signal processor means to perform a function in response.

3. The system of claim 2 wherein said first wireless communication means is arranged to receive a wireless radio signal from said remote communication means and in response thereto to transmit a signal to said GPS signal processor means which initiates a change in the performance of its data generation function.

4. The system of claim 3 wherein the signal transmitted to the GPS signal processor means initiates or stops data generation by the GPS signal processor means.

5. The system of claim 3 wherein the signal transmitted to the GPS signal processor initiates a change in processing parameters by the GPS signal processor means.

6. The system of claim 1 wherein said GPS antenna means, is mounted to an underside surface of said vehicle.

7. The system of claim 6 wherein said GPS antenna means, is mounted to the underside of said vehicle by magnetic means.

8. The system of claim 6 wherein said device having a GPS electromagnetic signal processor means connected to said first wireless communication means, and said GPS antenna means, are both mounted to the underside of said vehicle by permanent magnet means.

9. The system of claim 6 wherein said GPS antenna means is not mounted in direct line-of-sight orientation with a GPS electromagnetic signal transmitting, orbiting satellite.

10. The system of claim 1 wherein a wireless radio signal transmission received by said remote communication means from said first wireless communication means of said device, is digitized for communication with computer means.

11. The system of claim 10 comprising computer means in communication with said remote wireless communication means, said computer means being enabled to send data to said remote wireless communication means which initiates the transmission of a wireless radio signal by said remote communication means to said first wireless communication means, which initiates a change in the performance of data generation function by said GPS processor means.

12. The system of claim 11 wherein said computer means can be accessed through the internet for remote viewing, tracking and functional control of data produced by said GPS processor means.

13. In a GPS antenna assembly having stacked ground and positive plates separated by a separator plate, the improvement comprising said positive plate having an exposed face engaged by a polymeric composition containing particles of a conductive metal.

14. The GPS antenna assembly of claim 13 wherein said polymeric composition encases said stacked ground and positive plates separated by a separator plate, intimately engaging exposed surfaces of said stacked positive, ground and separator plate.

15. The GPS antenna assembly of claim 13 comprising a metal shield base plate stacked adjacent said base ground plate.

16. The GPS antenna of claim 15 wherein said metal shield base plate comprises an electronic circuit board in electrical communication with said positive plate which is enabled to enhance electromagnetic radio signals received by said positive plate.

17. The GPS antenna assembly of claim 16 comprising a metal shroud arranged spaced from and stacked adjacent to said electronic circuit board.

18. The GPS antenna assembly of claim 17 wherein said polymeric composition encases said stacked shroud, shield base plate, ground plate, separator plate and positive plate, intimately engaging exposed surfaces thereof.

19. The GPS antenna assembly of claim 13 wherein said conductive metal particles comprise magnesium carbonate.

20. The GPS antenna assembly of claim 19 wherein said polymeric composition comprises polyester resin, styrene monomer, talc, magnesium carbonate powder and sodium borosillicate.

21. The GPS antenna assembly of claim 13 wherein said antenna is mounted to the exterior surface of the short leg of an “L” shaped bracket, the long leg being arranged for quick mounting to the underside of a vehicle.

22. The GPS antenna assembly of claim 21 wherein said bracket comprises an electrically conductive metal and the exterior surface of the long side of the “L” comprises a ceramic magnet sufficient for mounting said antenna to a metallic underside of said vehicle.

23. The GPS antenna assembly of claim 22 wherein said stacked plates and polymeric composition containing particles of conductive metal of said antenna are isolated from electrical conductive contact with said metal bracket.

24. The GPS antenna assembly of claim 23 wherein said antenna is attached to said bracket by non-conductive means.

25. The GPS antenna assembly of claim 24 wherein said non-conductive means comprises an epoxy.

26. The GPS antenna assembly of claim 21, wherein the positive plate of the antenna is oriented to face the exterior surface of the short leg of the bracket.
